(19) United States
(12) Patent Application Publication
(10) Pub. No.: US 2015/0261868 A1
(43) Pub. Date: Sep. 17, 2015

(54) Method For Processing Information And Apparatus Thereof

(71) Applicant: Lenovo (Beijing) Co., Ltd., Beijing (CN)

(72) Inventor: Dong Li, Beijing (CN)

(21) Appl. No.: 14/458,763

(22) Filed: Aug. 13, 2014

(30) Foreign Application Priority Data
Mar. 17, 2014 (CN) 201410098208.1

(51) Int. Cl. G06F 17/30

(52) U.S. Cl. CPC G06F 17/30867

(57) ABSTRACT

A method for processing information and an apparatus thereof are provided according to the embodiments of the disclosure. The method for processing information includes: acquiring a first keyword; acquiring a first search instruction; sending the first keyword to the first search engine in responding to the first search instruction; and obtaining a first kind of search result and a second kind of search result fed back by the first search engine. The first kind of search result refers to M applications determined by performing a matching based on the attribute information by the first search engine, and the second kind of search result refers to network data determined by performing a matching based on the first keyword by the first search engine, and the first and the second kinds of search result are displayed.

### CROSS-REFERENCES TO RELATED APPLICATIONS

This application claims priority to Chinese Patent Application No. 201410098208.1, entitled “METHOD FOR PROCESSING INFORMATION AND APPARATUS THEREOF”, filed with the Chinese State Intellectual Property Office on Mar. 17, 2014, which is incorporated herein by reference in its entirety.

### FIELD

The present disclosure relates to the technical field of information processing, and in particular to a method for processing information and an apparatus thereof.

### BACKGROUND

At present, when a user searches for information via an electronic device, the electronic device may acquire search information which is input into a search bar by the user, and perform a search based on the search information to obtain search results. For example, when the user searches for pictures of a film star, the electronic device may capture the search information, such as the name of the film star, input into the search bar, and then generate a search instruction after acquiring a clicking action on a search button, to instruct the electronic device to call a search engine to search the matching contents to obtain the search results.

Through the above search operation, the electronic device may obtain a series of search results based on the search information, and the search results are network data determined by matching based on the search information by the search engine. In addition, it can be seen that the search results obtained in the present searching manner are only network data, and the search results are simple in types, therefore the information that the user obtains from the search results are limited.

### SUMMARY

It is to provide a method for processing information and an apparatus thereof, where besides network data obtained based on a first keyword, search results may include M applications obtained by performing a matching based on attribute information of the first keyword, and the search results are diversified in types, such that a user may obtain information from both the network data and the M applications at the same time, thereby increasing the amount of information that the user may obtain. The technical solution is described as follows.

A method for processing information is provided according to an embodiment of the disclosure, including:

acquiring a first keyword, where the first keyword is a search basis of a first search engine;

acquiring a first search instruction, where the first search instruction is configured to instruct the first search engine to perform a search;

sending the first keyword to the first search engine in responding to the first search instruction; and

obtaining a first kind of search result and a second kind of search result fed back by the first search engine, where first kind of search result refers to M applications determined by performing a matching based on attribute information of the first keyword by the first search engine in a case that the first search engine determines the attribute information of the first keyword, where M is an integer greater than or be equal to 1, where the second kind of search result refers to network data determined by performing a matching based on the first keyword by the first search engine, and the first kind of search result and the second kind of search result are displayed.

The method for processing information may also be applied to an electronic device, where the method further includes:

acquiring a triggering action on a first search result of the first kind of search result, where the first search result is corresponding to a first application;

starting the first application corresponding to the first search result in responding to the triggering action;

controlling the first application to perform a matching based on the first keyword with a first network service search engine corresponding to the first application and generating a third kind of search result, where the third kind of search result is network data determined by performing a matching based on the first keyword by the first network service search engine; and

displaying the third kind of search result on the first application.

The method for processing information may also be applied to an electronic device, where the method further includes:

scanning N local applications installed at the electronic device;

in a case that the N local applications installed on the electronic device includes a local application which is matched with the first kind of search result, generating a corresponding relation between the local application and the first search result in the first kind of search result to start the local application which is taken as the first application when the triggering action is responded to, where N is an integer greater than or be equal to 1.

The method for processing information may also be applied to an electronic device, where the method further includes:

in a case that N local applications installed at the electronic device do not include a local application which is matched with the first kind of search result,

starting the first application corresponding to the first search result and calling a webpage application, and obtaining a fourth kind of search result after a second network service search engine corresponding to the webpage application performs a matching based on the first keyword; and

displaying the fourth kind of search result on the webpage application.

The method for processing information may also be applied to a device at network side, where the method further includes:

acquiring a second keyword and a second search instruction, where the second search instruction is configured to instruct the first search engine to perform a search based on the second keyword;

sending the second keyword to the first search engine in responding to the second search instruction;

obtaining a fifth kind of search result fed back by the first search engine, where the fifth kind of search result is network data determined by performing a matching based on the second keyword by the first search engine;

acquiring a relevant record of a triggering action on the fifth kind of search result; and

marking an attribute of the second keyword as a first type of attribute in a case that the relevant result meets a predetermined condition.

An apparatus for processing information is further provided according to an embodiment of the disclosure, including:

a first acquisition unit, configured to acquire a first keyword, where the first keyword is a search basis of a first search engine;

a second acquisition unit, configured to acquire a first search instruction, where the first search instruction is configured to instruct the first search engine to perform a search;

a responding unit, configured to send the first keyword to the first search engine in responding to the first search instruction; and

a result obtaining unit, configured to obtain a first kind and a second kind of search result fed back by the first search engine, where the first kind of search result refers to M applications which are determined by performing a matching based on attribute information by the first search engine in a case that the first search engine determines the attribute information of the first keyword, where M is an integer greater than or be equal to 1, where the second kind of search result refers to network data determined by performing a matching based on the first keyword by the first search engine, and the first kind of search result and the second kind of search result are displayed.

The apparatus for processing information may be applied to an electronic device, where the apparatus further includes:

a third acquisition unit, configured to acquire a triggering action on the first search result of the first kind of search result, where the first search result is corresponding to a first application;

an operation responding unit, configured to respond to the triggering action;
a starting unit, configured to start the first application corresponding to the first search result;

a control unit, configured to control the first application to perform a matching based on the first keyword with a first network service search engine corresponding to the first application and generate a third kind of search result, where the third kind of search result is network data determined by performing a matching based on the first keyword by the first network service search engine; and

a displaying unit, configured to display the third kind of search result on the first application.

The apparatus for processing information may be applied to an electronic device, where the apparatus further includes:

a searching unit, configured to scan N local applications installed on the electronic device; and

an establishing unit, in a case that the N applications installed at the electronic device comprise a local application which is matched with the first kind of search result, configured to establish a corresponding relation between the local application and the first search result in the first kind of search result to start the local application which is taken as the first application when the triggering action is responded to, where N is an integer greater than or be equal to 1.

The apparatus for processing information may be applied to an electronic device, where the apparatus further includes:

an application generating unit, in a case that the N local applications installed on the electronic device do not include a local application which is matched with the first kind of search result, configured to start the first application corresponding to the first search result and call a webpage application, and obtain a fourth kind of search result after a second network service search engine corresponding to the webpage application performs a matching based on the first keyword;

the display unit, configured to display the fourth kind of search result on the webpage application.

The apparatus for processing information may be applied to a device at network side, where the apparatus further includes:

a fourth acquisition unit, configured to acquire a second keyword and a second search instruction, where the second search instruction is configured to instruct the first search engine to perform a search based on the second keyword;

an instruction responding unit, configured to send the second keyword to the first search engine in responding to the second search instruction;

a search result obtaining unit, configure to obtain a fifth kind of search result fed back by the first search engine, where the fifth kind of search result is network data determined by performing a matching based on the second keyword by the first search engine;

a fifth acquisition unit, configured to acquire a relevant record of a triggering action on the fifth kind of search result; and

a marking unit, configured to mark an attribute of the second keyword as an attribute of a first type in a case that the relevant result meets a predetermined condition.

Compared with the conventional technology, the disclosure has the following advantages.

By the method for processing information provided according to the embodiments of the disclosure, besides searching out the network data, M applications may be obtained by matching based on the attribute information of the first keyword, thereby diversifying the types of search result. In addition, the M applications and the network data may be displayed, such that a user may trigger any one of the M applications while acquiring information from the network data, such that the electronic device may start the triggered application and provide information for the user via the triggered application, increasing the amount of information which the user may obtain.

### BRIEF DESCRIPTION OF THE DRAWINGS

To make the technical solutions in the embodiments provided by the disclosure better understood, the drawings used in the disclosure will be briefly described in the following. Obviously, the drawings described in the following are only a few of the embodiments of the disclosure, and those skilled in the art may obtain other drawings according to these drawings without creative work.

FIG. 1 is a flow chart showing a method for processing information provided according to an embodiment of the disclosure;

FIG. 2 is a flow chart showing a method for processing information applied to an electronic device provided according to an embodiment of the disclosure;

FIG. 3 is a schematic display diagram of an electronic device provided according to an embodiment of the disclosure;

FIG. 4 is a flow chart showing another method for processing information applied to an electronic device provided according to an embodiment of the disclosure;

FIG. 5 is a flow chart showing a method for processing information applied to a device at a network side provided according to an embodiment of the disclosure;

FIG. 6 is a flow chart showing another method for processing information applied to a device at a network side provided according to an embodiment of the disclosure;

FIG. 7 is a schematic structure diagram of an apparatus for processing information provided according to an embodiment of the disclosure;

FIG. 8 is a schematic structure diagram of another apparatus for processing information applied to an electronic device provided according to an embodiment of the disclosure;

FIG. 9 is a schematic structure diagram of another apparatus for processing information applied to an electronic device provided according to an embodiment of the disclosure; and

FIG. 10 is a schematic structure diagram of an apparatus for processing information applied to a device at a network side provided according to an embodiment of the disclosure.

### DETAILED DESCRIPTION

The technical solutions according to the embodiments of the disclosure will be specified in conjunction with the drawings. Obviously, the disclosed embodiments are a few of the embodiments of the disclosure, rather than all of the embodiments. Other embodiments obtained by those skilled in the art without creative work based on the embodiments of the disclosure, fall into the scope of the disclosure.

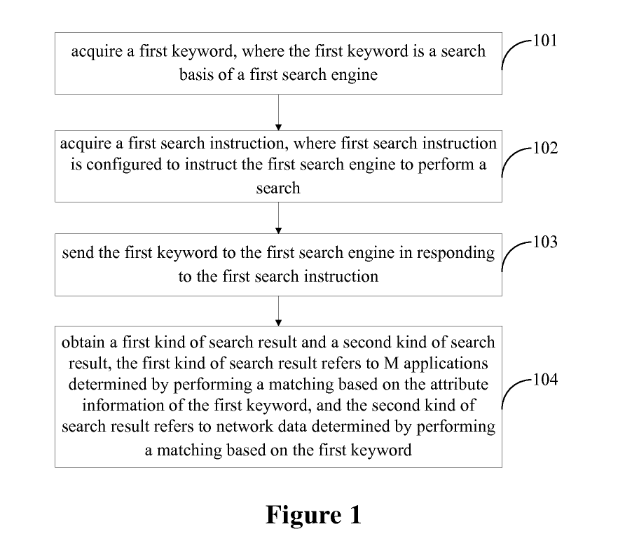

FIG. 1 is a flow chart showing a method for processing information provided according to an embodiment of the disclosure, the method may include Step 101 to Step 104 as follows.

Step 101 is to acquire a first keyword. The first keyword is a search basis of a first search engine. That is, the first search engine may search out, based on the first keyword, a result relevant to the first keyword, such as a text including the first keyword. For example, the first keyword is “case A”, and the first search engine may search out the results relevant to the keyword “case A”, where the search results may include the network data such as the written and the video reports about case A.

Step 102 is to acquire a first search instruction, where the first search instruction is configured to instruct the first search engine to perform a search. The first search instruction may be generated upon pressing the “Enter” key of the electronic device or clicking a search button on a search page associated to the first search engine.

Step 103 is to send the first keyword to the first search engine in responding to the first search instruction.

In a case that the first search instruction is acquired, the first keyword may be sent to the first search engine in responding to the first search instruction, and a search application may be started to search the contents relevant to the first keyword.

Step 104 is to obtain a first kind of search result and a second kind of search result fed back by the first search engine.

In an embodiment of the disclosure, the first kind of search result refers to M applications which are determined by performing a matching based on attribute information of the first keyword by the first search engine in a case that the first search engine determines the attribute information of the first keyword, where M is an integer greater than or be equal to 1. The second kind of search result refers to network data determined by performing a matching based on the first keyword by the first search engine, and the first kind of search result and the second kind of search result may be displayed.

In another word, besides the network data, M applications may be obtained by matching based on the attribute information of the first keyword, thereby diversifying the types of search result. In addition, the M applications and the network data may be displayed, such that a user may trigger any one of the M applications while acquiring information from the network data, to make the electronic device to start the triggered application and provide information for the user via the triggered application, thereby increasing the amount of information which the user may acquire.

It may be noted that, the method for processing information may be applied to a terminal side such as an electronic device, or a device such as server at the network side. When the device at the terminal side and the device at the network side implement respectively the method for processing information provided according to an embodiment of the disclosure, the procedures are more or less different. The method for processing information provided according to the embodiment of the disclosure may be described in the following by taking the device at terminal side or network side as the implementing bodies.

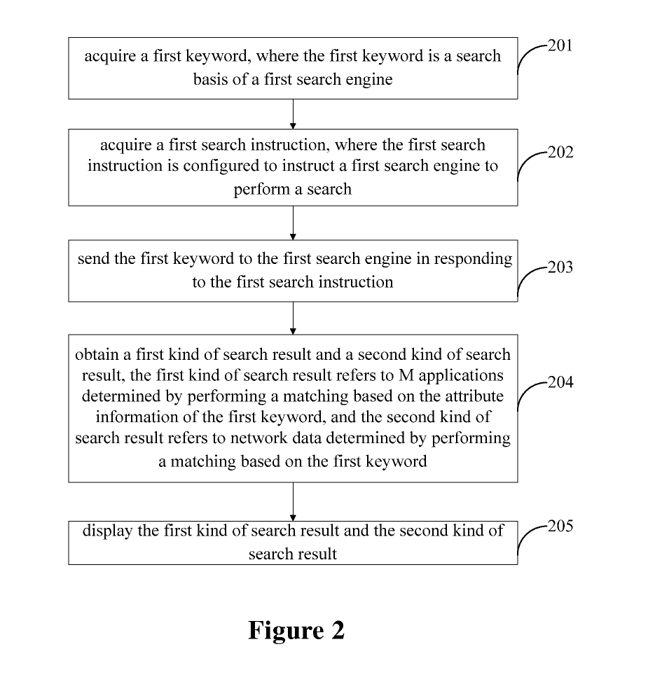

FIG. 2 is a flow chart showing a method for processing information provided according to an embodiment of the disclosure, and the method shown in the flow chart is applied to an electronic device which communicates with the device at network side via a data communication channel. The method for processing information provided according to an embodiment of the disclosure may include Step 201 to Step 205 as follows.

Step 201 is to acquire a first keyword. The first keyword is a search basis of a first search engine, i.e., the first search engine may search out, based on the first keyword, a result relevant to the first keyword, such as a text including the first keyword. For example, the first keyword is “case A”, and the first search engine may search out the results relevant to the keyword “case A”, where the search result may include the network data such as the written and the video reports about case A.

In an embodiment of the disclosure, the way to acquire the first keyword may include but not be limited to the following two ways.

In the embodiments, an electronic device includes an acoustic sensor. In a case that a first operating body aims at the electronic device and makes a sound, the acoustic sensor may capture the sound made by the first operating body, and then the electronic device may recognize the sound made by the first operating body by means of speech recognition technology to obtain a corresponding keyword. The first operating body may be a mouth, and the sound may be generated by a collision of lips or a vibration of vocal cords.

Alternatively, the sound made by the first operating body, may be sent by other devices. For example, the electronic device may include a main body and a remote control device which exchanges information with the main body. The remote control device includes an acoustic sensor configured to capture sound made by a first operating body, and the sound may be sent to the main body via a communication module of the remote control device, and then the main body may recognize the sound made by the first operating body by means of speech recognition technology.

In other embodiments, an electronic device includes a sensing unit which may acquire a position where a second operating body performs an operation, such as the position of an input part of the electronic device (e.g., hardware key or virtual key) where the second operating body touches. The positions where the second operating body performs operations may include multiple positions where the second operating body touches the input part, or a track of the points where the second operating body touches the input part.

The electronic device may determine a corresponding key through the multiple positions or the track, and obtain a corresponding character in conjunction with an input method employed by the electronic device, and then the electronic device may combine the characters to obtain a keyword.

The second operating body may be a finger, or a mouse or an electronic stylus operated by a user, and the embodiment of the disclosure is not limited in this aspect.

Step 202 is to acquire a first search instruction, where the first search instruction is configured to instruct a first search engine to perform a search.

Step 203 is to send the first keyword to the first search engine in responding to the first search instruction.

In an embodiment of the disclosure, the first search instruction is bound with a search control identifier. The electronic device acquires the first search instruction in a case that the search control identifier is triggered, and sends, via a data communication channel, the first keyword to the first search engine of a device at network side which communicates with the electronic device, and then starts a search application to perform a search based on the first keyword.

The search control identifier may be the “Enter” key of the electronic device or a search button on a search page associated with the first search engine. In a case that the first operating body performs a touch operation, the electronic device acquires, via a sensing unit, an operating point where the touch operation is performed, and then whether the “Enter” key or the search button is triggered may be determined based on the position of the operating point. In a case that the “Enter” key or the search button is triggered, it may be indicated that the first search instruction which is bound with the “Enter” key or the search button is triggered, and then the electronic device acquires the first search instruction and sends the search instruction to the first search engine.

The search page associated with the first search engine refers to a network search page provided by the first search engine and displayed on the electronic device. For example, if the first search engine is Baidu, the associated search page is a webpage of Baidu, and the corresponding search button is the button “Baidu search”.

Step 204 is to obtain a first kind of search result and a second kind of search result fed back by the first search engine.

Step 205 is to display the first kind of search result and the second kind of search result.

The first kind of search result refers to M applications which are determined by performing a matching based on attribute information by the first search engine in a case that the first search engine determines the attribute information of the first keyword, where M is an integer greater than or be equal to 1. The second kind of search result refers to network data determined by performing a matching based on the first keyword by the first search engine, and the first kind of search result and the second kind of search result may be displayed.

The attribute information of the first keyword indicates the type of the first keyword. The search engine obtains, based on results searched out based on the first keyword, a relevant record of a triggering action on the results. In a case that the relevant result meets a predetermined condition, the attribute of the first keyword may be marked as a first type of attribute.

The way to judge whether the relevant record meets the predetermined condition may include: judging whether the times of triggering actions on one kind of search result account for more than 80% of all the times of triggering actions on the result searched out based on the first keyword. If yes, it may be indicated that the relevant record meets the predetermined condition. That is, in an embodiment of the disclosure, the relevant record may refer to a proportion that the times of the triggering actions on a same kind of search result accounting for the times of all the triggering actions on the result searched out based on the first keyword, and the predetermined condition is that the proportion is more than 80%.

For example, the first keyword is “Wudaokou”, based on which the first search engine searches out a geographic position, a distribution of hotels and catering services of Wudaokou. Then the first search engine acquires a relevant record of the triggering actions on the search result and finds that more than 80% of the triggering actions correspond to the geographic position of Wudaokou, and then the attribute of the first keyword “Wudaokou” is marked as map, and the matched application is a map application.

For another example, the first keyword is “Wudaokou and restaurant”, based on which the first search engine searches out a geographic position, a distribution of hotels and catering services of Wudaokou. Then the first search engine acquires the relevant record of the triggering actions on the search result and searches out that more than 80% of the triggering actions correspond to the catering services of Wudaokou, and then the attribute of the first keyword “Wudaokou and restaurant” is marked as catering service, and the matched application is a catering service application.

In a case that the first search engine determines M applications and network data, the M applications and the network data may be sent to the electronic device via a data communication channel, and then the electronic device may display the M applications and the network data at a display area.

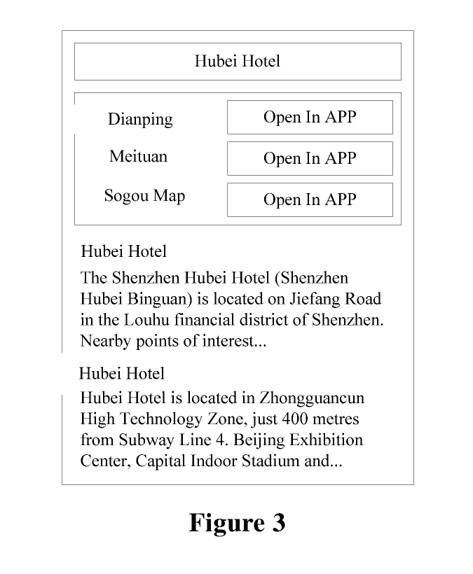

FIG. 3 shows a way of displaying the M applications and the network data by the electronic device. Entry icons-Open In App of the applications are provided while the M applications are displayed. The entry icon is a quick entrance for the electronic device to start the application. In a case that the electronic device detects that the entry icon is clicked, the electronic device may start the application corresponding to the entry icon, which may realize a quick start of the application compared with the conventional technology that the electronic device searches out the application and then starts the application.

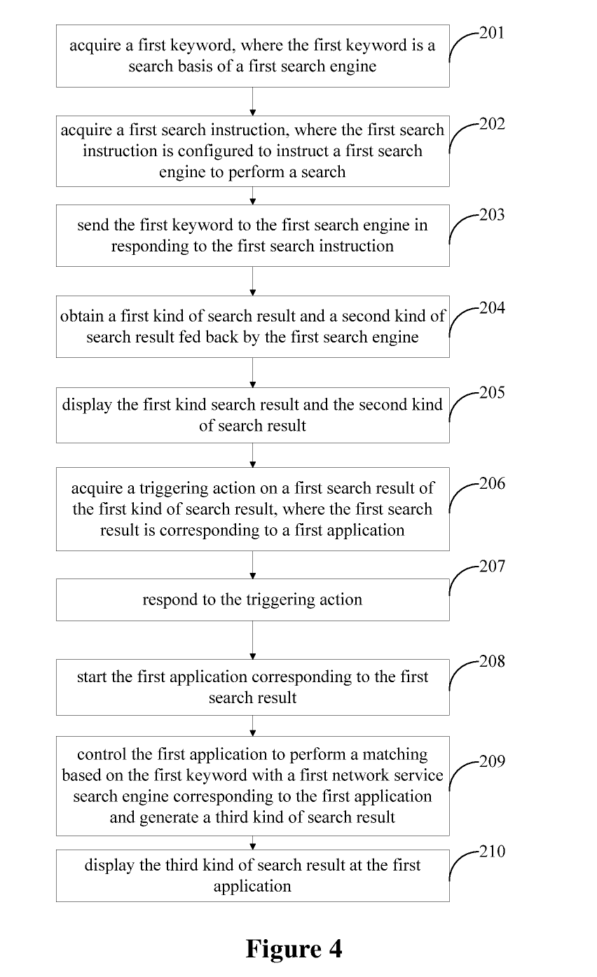

A process of a quick start of an application may be shown in FIG. 4, which shows another flow chart of a method for processing information provided according to an embodiment of the disclosure. Based on the method shown in FIG. 2, the method further includes Step 206 to Step 210 as follows.

Step 206 is to acquire a triggering action corresponding to a first search result of the first kind of search result, where the first search result is corresponding to a first application.

It may be understood that, in a case that the electronic device acquires the first kind of search result, the electronic device may display, on the displaying area of the electronic device, the first search results corresponding to the M applications rather than run directly the applications, where a first search result shows a summary and an entry icon of the first application corresponding to the first search result.

As shown in FIG. 3, in a case that the electronic device searches for Hubei Hotel, three applications-“Dianping”, “MeiTuan” and “Sogou Map”, are obtained from the first kind of search result, and the information provided by the three applications and the entry icons of each application are displayed on the displaying area. Therefore the electronic device may need to acquire a triggering action corresponding to a first search result to run the first application corresponding to the first search result.

The triggering action refers to that a second operating body clicks an entry icon or a summary shown in FIG. 3. In a case that the second operating body clicks the entry icon, the sensing unit of the electronic device may detect multiple operating points, and the entry icon which the triggering action is performed on may be determined based on the coordinates of the multiple operating points. In addition, each entry icon corresponds to a first search result of the first kind of search result, and each first search result corresponds to a first application. Therefore, the first search result and the first application corresponding to the triggering action may be determined by sensing the triggering action.

As shown in FIG. 3, the electronic device detects that the coordinates of the operating point is corresponding to the entry icon of “Dianping”, and then the electronic device may start the application of “Dianping” while responding to the triggering action.

Step 207 is to respond to the triggering action.

Step 208 is to start the first application corresponding to the first search result.

Step 209 is to control the first application to perform a matching based on the first keyword with a first network service search engine corresponding to the first application and generate a third kind of search result.

Step 210 is to display the third kind of search result on the first application.

Upon starting the first application, the electronic device may send the first keyword to a first network service search engine, and call the first network service search engine to search the Internet based on the first keyword to obtain, from the network data provided by the Internet, the third kind of search result matched with the first keyword. The third kind of search result is network data determined by performing a matching based on the first keyword by the first network service search engine.

It may be noted that, in an embodiment of the disclosure, the electronic device determines the type of the first application to be started, based on whether an application installed on the electronic device is matched with the first kind of search result. In a case that the application is matched with the first type of search result, it is indicated that the electronic device has an application corresponding to the first kind of search result, and the application may be started; in a case that there is no application installed on the electronic device matched with the first type of search result, the electronic device may start a webpage application. Therefore, in a case that the electronic device determines the application matched with the first kind of search result, the electronic device may scan the installed applications. In a case that N applications installed on the electronic device include the application matched with the first kind of search result, a corresponding relation between the application and the first search result of the first kind of search result may be established, such that the electronic device may start directly the application corresponding to the first search result in a case that the electronic device detects the triggering action on the first search result of the first kind of search result.

In a case that there is no application matched with the first kind of search result in the N applications installed on the electronic device, the electronic device may call a webpage application when the electronic device starts the first application corresponding to the first search result, and obtain a fourth kind of search result, after a second network service search engine corresponding to the webpage application performs a matching based on the first keyword. The fourth kind of search result may be displayed on the webpage application.

The webpage application is in a form of Web, i.e., a webpage version application. In a case that an electronic device calls a webpage application, the electronic device sends a first keyword to a second network service search engine corresponding to the webpage application and call the second network service search engine; the second network service search engine searches the Internet based on the first keyword, to obtain, from network data provided by the Internet, a fourth kind of search result corresponding to the first keyword. The fourth kind of search result is the network data determined by performing a matching based on the first keyword by the second network service search engine.

It is can be seen from the above solutions, after obtaining the first kind of search result, the electronic device may start the first application based on a triggering action on the first search result of the first kind of search result. The starting speed of application may be enhanced compared with the conventional technology in which the application is searched based on the first search result. In addition, the electronic device also provides two kinds of application. In a case that the electronic device has the application corresponding to the first kind of search result, the electronic device may further start the application to perform a matching based on the first keyword after acquiring the triggering action; otherwise, the electronic device may call a webpage application to perform a matching based on the first keyword.

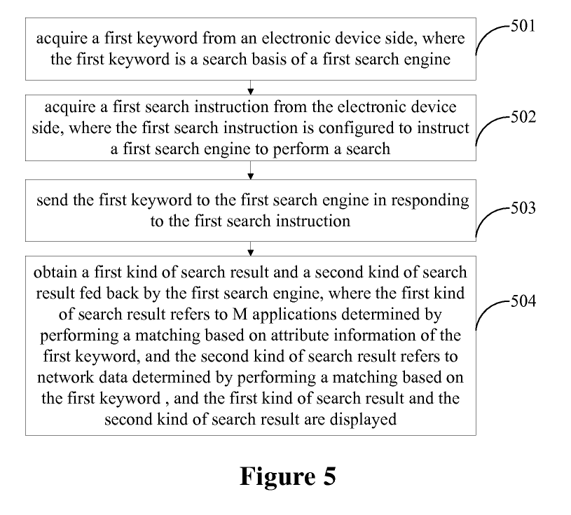

FIG. 2 to FIG. 4 show a method for processing information applied to an electronic device, and the method for processing information provided according to an embodiment of the disclosure may also be applied to a device at network side, where the device at network side communicates with an electronic device via a data communication channel, of which a flow chart is shown in FIG. 5, which may include Step 501 to Step 504.

Step 501 is to acquire a first keyword from an electronic device side. The first keyword is a search basis of a first search engine, i.e., the first search engine may search out, based on the first keyword, a result relevant to the first keyword, such as a text including the first keyword. For example, the first keyword is “case A”, and then the first search engine may search out the results relevant to the keyword “case A”, where the search result may include the network data such as the written and the video reports about case A.

In an embodiment of the disclosure, a first keyword is acquired by an electronic device. After acquiring the first keyword, the electronic device may send the first keyword to a device at network side via a data communication channel. The way for the electronic device to acquire the first keyword may refer to the description of the method embodiment of the electronic device side, and the description thereof is omitted herein.

Step 502 is to acquire a first search instruction from the electronic device side, where the first search instruction is configured to instruct a first search engine to perform a search.

Step 503 is to respond to send the first keyword to the first search engine in responding to the first search instruction.

In an embodiment of the disclosure, the first search instruction is bound with a search control identifier. The electronic device acquires the first search instruction in a case that the search control identifier is triggered, and sends the first search instruction to the device at network side via the data communication channel. And then the first search engine of the device at network side may perform a search based on the first keyword.

The search control identifier may be the “Enter” key of the electronic device or a search button on a search page displayed on the electronic device, where the search page is associated with the first search engine. In a case that a first operating body performs a touch operation, the electronic device acquires, via a sensing unit, an operating point where the touch operation is performed, and then whether the “Enter” key or the search button is triggered may be determined based on the operating point. In a case that the “Enter” key or the search button is triggered, it may be indicated that the first search instruction which is bound with the “Enter” key or the search button is triggered, and then the electronic device acquires the first search instruction and send the search instruction to the first search engine.

The search page associated with the first search engine refers to a network search page provided by the first search engine and displayed on the electronic device. For example, if the first search engine is Baidu, the associated search page is a webpage of Baidu, and the corresponding search button is the button “Baidu search”.

After acquiring the first search instruction, the device at network side may send the first keyword to the first search engine and then start a search application to make the first search engine to perform a search based on the first keyword.

Step 504 is to obtain a first kind of search result and a second kind of search result fed back by the first search engine. The first kind of search result refers to M applications determined by performing a matching based on attribute information of the first keyword by the first search engine in a case that the first search engine determines the attribute information of the first keyword, where M is an integer greater than or be equal to 1. The second kind of search result refers to network data determined by performing a matching based on the first keyword by the first search engine, and the first kind of the search result and the second kind of search result may be displayed.

After determining the first kind of search result and the second kind of search result, the device at network side may send the two kinds of search result to the electronic device via the data communication channel, and then the electronic device may display the two kinds of search result.

The attribute information of the first keyword indicates the type of the first keyword. The search engine obtains, based on results searched out based on the first keyword, a relevant record of a triggering action on the results. In a case that the relevant result meets a predetermined condition, the attribute of the first keyword may be marked as a first type of attribute.

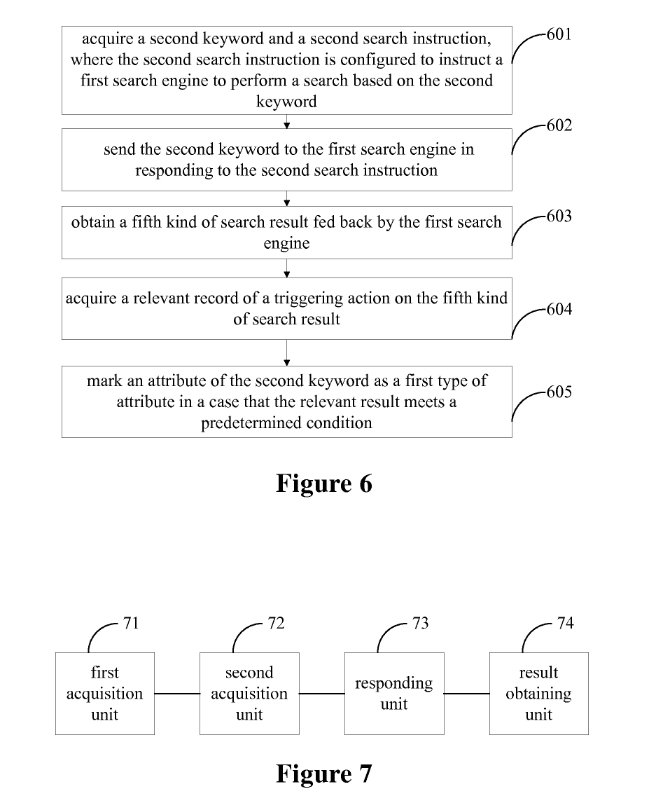

By taking a second keyword for example, a process of marking an attribute of a keyword in a method for processing information provided according to an embodiment of the disclosure may be described in the following. As show in FIG. 6, the process may include Step 601 to Step 605.

Step 601 is to acquire a second keyword and a second search instruction, where the second search instruction is configured to instruct a first search engine to perform a search based on the second keyword.

Step 602 is to send the second keyword to the first search engine in responding to the second search instruction.

In an embodiment of the disclosure, the process from Step 601 to Step 602 is as same as the process from Step 501 to Step 503, and the description thereof is omitted herein.

Step 603 is to obtain a fifth kind of search result fed back by the first search engine, where the fifth kind of search result is network data determined by performing a matching based on the second keyword by the first search engine.

Step 604 is to acquire a relevant record of a triggering action on the fifth kind of search result.

Step 605 is to mark an attribute of the second keyword as an attribute of a first type in a case that the relevant result meets a predetermined condition.

In an embodiment of the disclosure, the relevant record may refer to a proportion that the times of the triggering action on one kind of search result accounting for the times of all the triggering actions on the result searched out based on the first keyword, and the predetermined condition is that the proportion is more than 80%.

For example, the second keyword is “Wudaokou”, based on which the second search engine searches out a geographic position result, a distribution of hotels and catering services of Wudaokou. Then the second search engine acquires a relevant record of the triggering actions on the search result and search outs that more than 80% of the triggering actions correspond to the geographic position result of Wudaokou, and then the attribute of the second keyword “Wudaokou” is marked as map.

For another example, the second keyword is “Wudaokou and restaurant”, based on which the second search engine searches out a geographic position result, a distribution of hotels and catering services of Wudaokou. Then the second search engine acquires the relevant record of the triggering actions on the search result and searches out that more than 80% of the triggering actions correspond to the catering services of Wudaokou, and then the attribute of the second keyword “Wudaokou and restaurant” is marked as catering services.

In an embodiment of the disclosure, an attribute of a keyword is marked based on a proportion of the triggering actions on the keyword, and the proportion of triggering actions reflects the actions of the majority of operating bodies to some extent, such that the attribute of the keyword may be in keeping with the intentions of the majority of users, and then an application which is matched based on the attribute of the keyword may be in keeping with the intentions of the users, thereby improving a user experience while realizing a quick start of the application.

Corresponding to the method embodiments, an apparatus for processing information is also provided according to an embodiment of the disclosure, of which a schematic structure diagram is shown in FIG. 7. The apparatus for processing information may include a first acquisition unit 71, a second acquisition unit 72, a responding unit 73 and a result obtaining unit 74.

The first acquisition unit 71 is configured to acquire a first keyword, where the first keyword is a search basis of a first search engine. That is, the first search engine may search out, based on the first keyword, a result relevant to the first keyword, such as a text including the first keyword. For example, the first keyword is “case A”, and then the first search engine may search out the results relevant to the keyword “case A”, where the search result may include the network data such as the written and the video report about case A.

The second acquisition unit 72 is configured to acquire a first search instruction, where the first search instruction is configured to instruct the first search engine to perform a search. In addition, the first search instruction may be generated after the “Enter” key of the electronic device is pressed or after a search button on a search page associated to the first search engine is clicked.

The responding unit 73 is configured to send the first keyword to the first search engine in responding to the first search instruction. In a case that the second acquisition unit 72 acquires the first search instruction, the responding unit 73 may send the first keyword to the first search engine in responding to the first search instruction, and a search application may be started to search for the result relevant to the first keyword.

The result obtaining unit 74 is configured to obtain a first kind of search result and a second kind of search result fed back by the first search engine. The first kind of search result refers to M applications which are determined by performing a matching based on attribute information by the first search engine in a case that the first search engine determines the attribute information of the first keyword, where M is an integer greater than or be equal to 1. The second kind of search result refers to network data determined by performing a matching based on the first keyword by the first search engine, and the first king of search result and the second kind of search result may be displayed.

The attribute information of the first keyword indicates the type of the first keyword. The search engine obtains, based on results searched out based on the first keyword, a relevant record of a triggering action on the results. In a case that the relevant result meets a predetermined condition, the attribute of the first keyword may be marked as a first type of attribute.

Therefore, besides the network data, M applications may be obtained by matching based on the attribute information of the first keyword, thereby diversifying the types of search result. In addition, the M applications and the network data may be displayed, such that a user may trigger any one of the M applications while acquiring information from the network data, to make the electronic device to start the triggered application and provide information for the user via the triggered application, thereby increasing the amount of information which the user may acquired.

It may be noted that, the apparatus for processing information may be applied to a terminal side such as an electronic device and a device at network side such as a server. The description of the method embodiment may provide a reference for the process that the devices at terminal and network sides process information via the apparatus for processing information provided according to the embodiment of the disclosure, and detailed description thereof is omitted herein.

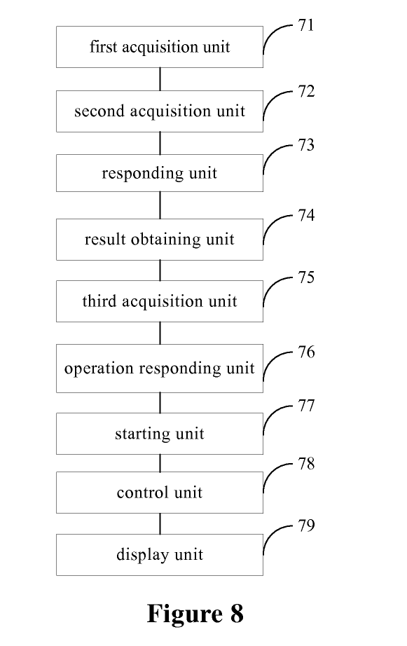

FIG. 8 is a schematic structure diagram of an apparatus for processing information applied to an electronic device provided according to an embodiment of the disclosure. Based on FIG. 7, the apparatus may further include a third acquisition unit 75, an operation responding unit 76, a starting unit 77, a control unit 78 and a display unit 79.

The third acquisition unit 75 is configured to acquire a triggering action on the first search result of the first kind of search result, where the first search result is corresponding to a first application.

The operation responding unit 76 is configured to response to the triggering action.

The starting unit 77 is configured to start the first application corresponding to the first search result.

It may be understood that, in a case that the electronic device acquires the first kind of search result, the electronic device may display on the displaying area of the electronic device the first search results corresponding to the M applications rather than run directly the matched applications, where a first search result describes a summary and an entry icon of the first application corresponding to the first search result.

As shown in FIG. 3, in a case that the electronic device searches for Hubei Hotel, three applications-“Dianping”, “Meituan” and “Sogou Map”, are obtained from the first kind of search result, and the information provided by the three applications and the entry icon of each application are displayed on the displaying area. Therefore, when the electronic device applies the apparatus for processing information, the third acquisition unit 75 may need to acquire a triggering action corresponding to a first search result to run the first application corresponding to the first search result.

The triggering action refers to that a second operating body clicks an entry icon or a summary shown in FIG. 3. In a case that the second operating body clicks the entry icon, the third acquisition unit 75 may detect multiple operating points via a sensing unit of the electronic device, and the entry icon which the triggering action is performed on may be determined based on the coordinates of the multiple operating points. In addition, each entry icon corresponds to a first search result of the first kind of search result, and each first search result corresponds to a first application. Therefore, the first search result and the first application corresponding to the triggering action may be determined by sensing the triggering action.

As shown in FIG. 3, the third acquisition unit 75 detects via the sensing unit that the coordinate of the operating point is corresponding to the entry icon of “Dianping”, and then the third acquisition unit 75 may start the application of “Dianping” application while responding to the triggering action.

The control unit 78 is configured to control the first application to perform a matching based on the first keyword with a first network service search engine corresponding to the first application and generate a third kind of search result, where the third kind of search result is network data determined by performing a matching based on the first keyword by the first network service search engine.

Upon starting the first application, the control unit 78 may send the first keyword to a first network service search engine, and call the first network service search engine to perform a search the Internet based on the first keyword to obtain, from the network data provided by the Internet, the third kind of search result matched with the first keyword. The third kind of search result is network data determined by performing a matching based on the first keyword by the first network service search engine.

The display unit 79 is configured to display the third search result on the first application.

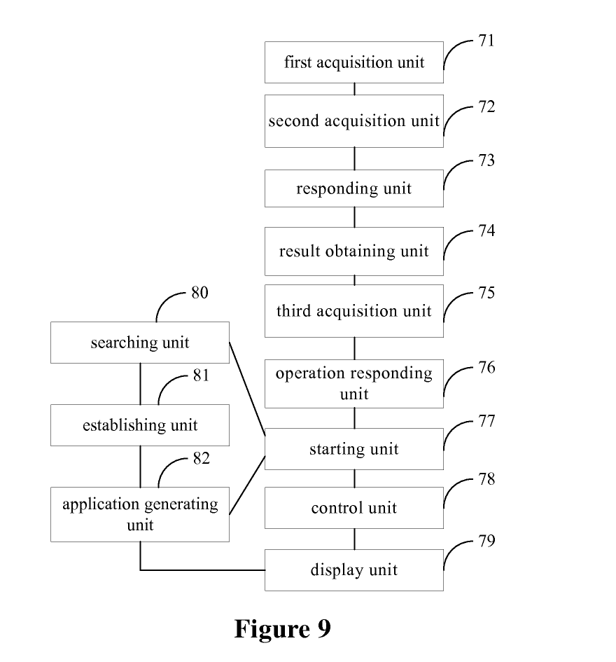

In addition, the apparatus for processing information applied to the electronic device may further control the electronic device to start a local application installed or a webpage application, of which the schematic structure diagram is shown in FIG. 9. Based on FIG. 8, the apparatus may further include a searching unit 80, an establishing unit 81 and an application generating unit 82.

The searching unit 80 is configured to scan N applications installed on the electronic device.

The establishing unit 81 is configured to generate a corresponding relation between the local application and the first search result in the first kind of search result to start the local application which is taken as the first application when the triggering action is responded to, in a case that the N local applications installed on the electronic device include the application which is matched with the first kind of search result, where N is an integer greater than or be equal to 1.

The application generating unit 82 is configured to start the first application corresponding to the first search result and call a webpage application in a case that N local applications installed on the electronic device do not include the application which is matched with the first kind of search result, and obtain a fourth kind of search result, after a second network service search engine corresponding to the webpage application performs a matching based on the first keyword. The fourth kind of search result may be displayed on the webpage application by the display unit 79.

The webpage application is in a form of Web, i.e., a webpage version application. In a case that an electronic device calls a webpage application, the electronic device sends a first keyword to a second network service search engine corresponding to the webpage application and call the second network service search engine; the second network service search engine searches the Internet based on the first keyword, to obtain, from network data provided by the Internet, a fourth kind of search result corresponding to the first keyword.

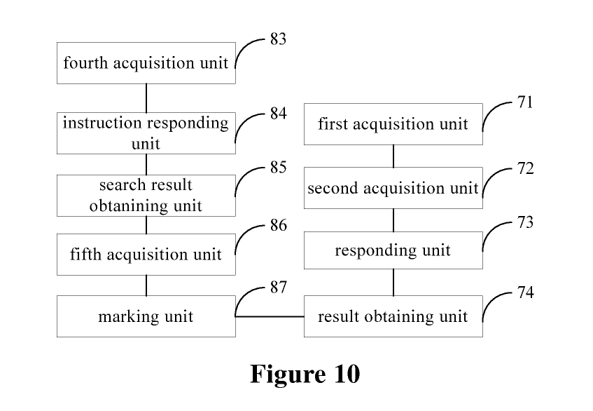

In a case that the apparatus for processing information provided according to an embodiment of the disclosure is applied to a device at network side, the information processing unit is further configured to mark an attribute of a keyword. In view of this, based on the apparatus for processing information shown in FIG. 7, the apparatus may further include a fourth acquisition unit 83, an instruction responding unit 84, a search result obtaining unit 85, a fifth acquisition unit 86 and a marking unit 87 as shown in FIG. 10.

The fourth acquisition unit 83 is configured to acquire a second keyword and a second search instruction, where the second search instruction is configured to instruct a first search engine to perform a search based on the second keyword.

It may be noted that, the second keyword and the second search instruction are to distinguish the first keyword and the first search result which are used to match applications. Without special meaning, it is intended to make a general reference to a keyword and a search instruction.

The instruction responding unit 84 is configured to send the second keyword to the first search engine in responding to the second search instruction.

The search result obtaining unit 85 is configure to obtain a fifth kind of search result fed back by the first search engine, where the fifth kind of search result is network data determined by performing a matching based on the second keyword by the first search engine.

The fifth acquisition unit 86 is configured to acquire a relevant record of a triggering action on the fifth kind of search result.

The marking unit 87 is configured to mark an attribute of the second keyword as an attribute of a first type in a case that the relevant result meets a predetermined condition.

In an embodiment of the disclosure, the relevant record may refer to a proportion that the times of the triggering action on one kind of search result accounting for the times of all the triggering actions on the result searched out based on the first keyword, and the predetermined condition is that the proportion is more than 80%.

For example, the second keyword is “Wudaokou”, based on which the second search engine searches out a geographic position, a distribution of hotels and catering services of Wudaokou. Then the second search engine acquires a relevant record of the triggering actions on the search result and finds that more than 80% of the triggering actions corresponds the geographic position of Wudaokou, and then the attribute of the second keyword “Wudaokou” is marked as map.

For another example, the second keyword is “Wudaokou and restaurant”, based on which the second search engine searches out a geographic position, a distribution of hotels and catering services of Wudaokou. Then the second search engine acquires the relevant record of the triggering actions on the search result and finds that more than 80% of the triggering actions correspond to the catering services of Wudaokou, and then the attribute of the second keyword “Wudaokou and restaurant” is marked as catering services.

In an embodiment of the disclosure, an attribute of a keyword is marked based on a proportion of the triggering actions on the keyword, and the proportion of triggering actions reflects the actions of the majority of operating bodies to some extent, such that the attribute of the keyword may be in keeping with the intentions of the majority of users, and then an application which is matched based on the attribute of the keyword may be in keeping with the intentions of the users, thereby improving a user experience while realizing a quick start of the application.

It may be noted that, the embodiments of the disclosure are described progressively, and each embodiment focuses on different aspects, and the same or similar part of the embodiments may make a reference to each other. Because the apparatus embodiments are similar to the method embodiments, the description of the device embodiments is simple, and the description of the method embodiments may make a reference to the apparatus embodiments.

At last, it may be also noted that the relationship terminologies such as “first”, “second” and the like are only used herein to distinguish one entity or operation from another, rather than to necessitate or imply that the actual relationship or order exists between the entities or operations. Furthermore, terms of “include”, “comprise” or any other variants are intended to be non-exclusive. Therefore, a process, method, article or device including a plurality of elements includes not only the elements but also other elements that are not enumerated, or also include the elements inherent for the process, method, article or device. Unless expressively limited otherwise, the statement “comprising (including) one . . . ” does not exclude the case that other similar elements may exist in the process, method, article or device.

To facilitate the description, the apparatus is described by distributing the functions to different units. Alternatively, in the implementation of the disclosure, the functions of the units may be implemented in one or more software and/or hardware.

By the foregoing description, the method and apparatus for processing information provided by the disclosure are detailed, and the principle and implementation are described by introducing the embodiments. The foregoing description of the embodiments is only to facilitate the understanding of the method and the core concept of the disclosure rather than to limit the disclosure. The variation and replacement made by those skilled in the art within the technical scope of the disclosure fall into the protection scope of the disclosure. In summary, the description of the specification is not meant limit the disclosure.

1. A method for processing information, comprising:
acquiring a first keyword, wherein the first keyword is a search basis of a first search engine;
acquiring a first search instruction, wherein the first search instruction is configured to instruct the first search engine to perform a search;
sending the first keyword to the first search engine in responding to the first search instruction; and
obtaining a first kind of search result and a second kind of search result fed back by the first search engine, wherein the first kind of search result refers to M applications determined by performing a matching based on attribute information of the first keyword by the first search engine in a case that the first search engine determines the attribute information of the first keyword, wherein M is an integer greater than or be equal to 1, wherein the second kind of search result refers to network data determined by performing a matching based on the first keyword by the first search engine, and the first kind of search result and the second kind of search result are displayed.

2. The method according to claim 1, wherein the method is applied to an electronic device, wherein the method further comprises:
acquiring a triggering action on a first search result of the first kind of search result, wherein the first search result is corresponding to a first application;
starting the first application corresponding to the first search result in responding to the triggering action;
controlling the first application to perform a matching based on the first keyword with a first network service search engine corresponding to the first application and generating a third kind of search result, wherein the third kind of search result is network data determined by performing a matching based on the first keyword by the first network service search engine; and
displaying the third kind of search result on the first application.

3. The method according to claim 2, wherein the method further comprises:
scanning N local applications installed on the electronic device;
in a case that the N local applications installed on the electronic device comprises a local application which is matched with the first kind of search result, generating a corresponding relation between the local application and the first search result in the first kind of search result to start the local application which is taken as the first application when the triggering action is responded to, wherein N is an integer greater than or be equal to 1.

4. The method according to claim 3, wherein the method further comprises:
in a case that the N local applications installed on the electronic device do not comprise a local application which is matched with the first kind of search result, starting the first application corresponding to the first search result and calling a webpage application, and obtaining a fourth kind of search result after a second network service search engine corresponding to the webpage application performs a matching based on the first keyword; and
displaying the fourth kind of search result on the webpage application.

5. The method according to claim 1, wherein the method is applied to a device at network side, wherein the method further comprises:
acquiring a second keyword and a second search instruction, wherein the second search instruction is configured to instruct the first search engine to perform a search based on the second keyword;
sending the second keyword to the first search engine in responding to the second search instruction;
obtaining a fifth kind of search result fed back by the first search engine, wherein the fifth kind of search result is network data determined by performing a matching based on the second keyword by the first search engine;
acquiring a relevant record of a triggering action on the fifth kind of search result; and
marking an attribute of the second keyword as a first type of attribute in a case that the relevant result meets a predetermined condition.

6. An apparatus for processing information, comprising:
a first acquisition unit, configured to acquire a first keyword, wherein the first keyword is a search basis of a first search engine;
a second acquisition unit, configured to acquire a first search instruction, wherein the first search instruction is configured to instruct the first search engine to perform a search;
a responding unit, configured to send the first keyword to the first search engine in responding to the first search instruction;
a result obtaining unit, configured to obtain a first kind of search result and a second kind of search result fed back by the first search engine, wherein the first kind of search result refers to M applications which are determined by performing a matching based on attribute information of the first keyword by the first search engine in a case that the first search engine determines the attribute information of the first keyword, wherein M is an integer greater than or be equal to 1, wherein the second kind of search result refers to network data determined by performing a matching based on the first keyword by the first search engine, and the first and the second kinds of search result are displayed.

7. The apparatus according to claim 6, wherein the apparatus is applied to an electronic device, wherein the apparatus further comprises:
a third acquisition unit, configured to acquire a triggering action on the first search result of the first kind of search result, wherein the first search result is corresponding to a first application;
an operation responding unit, configured to respond to the triggering action;
a starting unit, configured to start the first application corresponding to the first search result;
a control unit, configured to control the first application to perform a matching based on the first keyword with a first network service search engine corresponding to the first application and generate a third kind of search result, wherein the third kind of search result is network data determined by performing a matching based on the first keyword by the first network service search engine; and
a displaying unit, configured to display the third kind of search result on the first application.

8. The apparatus according to claim 7, wherein the apparatus further comprises:
a searching unit, configured to scan N local applications installed on the electronic device;
an establishing unit, in a case that the N applications installed at the electronic device comprise a local application which is matched with the first kind of search result, configured to establish a corresponding relation between the local application and the first search result in the first kind of search result to start the local application which is taken as the first application when the triggering action is responded to, wherein N is an integer greater than or be equal to 1.

9. The apparatus according to claim 8, wherein the apparatus further comprises:
an application generating unit, in a case that the N local applications installed on the electronic device do not comprise a local application which is matched with the first kind of search result, configured to start the first application corresponding to the first search result and call a webpage application, and obtain a fourth kind of search result after a second network service search engine corresponding to the webpage application performs a matching based on the first keyword;
the display unit, configured to display the fourth kind of search result on the webpage application.

10. The apparatus according to claim 6, wherein the apparatus is applied to a device at network side, wherein the apparatus further comprises:
a fourth acquisition unit, configured to acquire a second keyword and a second search instruction, wherein the second search instruction is configured to instruct the first search engine to perform a search based on the second keyword;
an instruction responding unit, configured to send the second keyword to the first search engine in responding to the second search instruction;
a search result obtaining unit, configure to obtain a fifth kind of search result fed back by the first search engine, wherein the fifth kind of search result is network data determined by performing a matching based on the second keyword by the first search engine;
a fifth acquisition unit, configured to acquire a relevant record of a triggering action on the fifth kind of search result; and
a marking unit, configured to mark an attribute of the second keyword as a first type of attribute in a case that the relevant result meets a predetermined condition.
